(19) United States
(12) Patent Application Publication
(10) Pub. No.: US 2024/0050302 A1
(43) Pub. Date: Feb. 15, 2024

(54) WALKING AID CONVENIENT TO FOLD AND VERY SMALL IN SIZE AFTER BEING FOLDED

(71) Applicant: Zhongshan Derui Medical Technology Co., Ltd., Zhongshan Ciy (CN)

(72) Inventors: Shixiong Liang, Yangchun City (CN); Xiang Yu, Zhongshan (CN)

(73) Assignee: Zhongshan Derui Medical Technology Co., Ltd., Zhongshan City (CN)

(21) Appl. No.: 17/966,631

(22) Filed: Oct. 14, 2022

(30) Foreign Application Priority Data
Aug. 11, 2022 (CN) 202210966635.1

(51) Int. Cl. A61H 3/00

(52) U.S. Cl. CPC A61H 3/00; A61H 2201/0161; A61H 2201/1676; A61H 2201/1635

(57) ABSTRACT

The present invention discloses a walking aid with a small folded size, comprising inverted left and right U-shaped tubes. Left and right connecting pieces are hinged to front sides of the left and right U-shaped tubes respectively; the left connecting piece is connected with the right connecting piece through a connecting tube; first elastic sheets are mounted on an inner side of a front part of the left U-shaped tube and the right U-shaped tube as well, and each is provided with a first positioning column; limiting grooves, corresponding to the first positioning columns, are formed in outer sides of the left and right connecting pieces; and fixing sleeves are mounted on the front sides of the left and right U-shaped tubes respectively through rivets. The present invention is convenient to fold and stretch, good in use effect, very small in packaging size and saving in logistics cost.

### REFERENCE TO PRIOR APPLICATION

This application claims priority to Chinese Patent Application 202210966635.1, filed on Aug. 11, 2022, which is incorporated herein by reference.

### TECHNICAL FIELD

The present invention relates to the technical field of walking aids, in particular to a walking aid convenient to fold and very small in size after being folded.

### BACKGROUND

A walking aid is a relatively common auxiliary tool which is used for supporting a crippled person and making the person capable of taking care of himself/herself and walk like a normal person. There are a great variety of walking aids; however, the existing walking aids are uneven in overall quality and have the disadvantages of inconvenience in folding, packaging and transportation, unsatisfactory effect, large packaging size, high production cost and the like. Therefore, in order to overcome the disadvantages in the prior art, it is necessary to make improvements in the prior art.

### SUMMARY

An objective of the present invention is to make innovations on the basis of overcoming the disadvantages and deficiencies in the prior art and provide a walking aid convenient to fold and very small in size after being folded, which has a simple structure and is low in production cost. The present invention is implemented by the following technical solution:

A walking aid convenient to fold and very small in size after being folded comprises a left U-shaped tube and a right U-shaped tube which are inverted; a left connecting piece is hinged to a front side of the left U-shaped tube; a right connecting piece is hinged to a front side of the right U-shaped tube; the left connecting piece is connected with the right connecting piece through a middle connecting tube; first elastic sheets are mounted on an inner side of a front part of the left U-shaped tube and an inner side of a front part of the right U-shaped tube respectively, and each is provided with a first positioning column; limiting grooves, corresponding to the first positioning columns, are formed in an outer side of the left connecting piece and an outer side of the right connecting piece respectively; fixing sleeves are mounted on the front side of the left U-shaped tube and the front side of the right U-shaped tube through rivets and are hinged to handles through a handle pins respectively; a spring abutting to each fixing sleeve is mounted at the upper part of each handle; an interlocking screw is mounted at a lower part of each handle; locking holes, corresponding to the interlocking screws, are formed in the front part of the left U-shaped tube and the front part of the right U-shaped tube respectively; foot tube connecting tubes are sleeved on an inner side of a bottom of the left U-shaped tube and an inner side of a bottom of the right U-shaped tube; a foot tube is sleeved on an outer side of each foot tube connecting tube; a second elastic sheet is mounted on an inner side of each foot tube connecting tube and is provided with a second positioning column; and a plurality of second positioning holes, corresponding to each second positioning column, are formed in each foot tube.

Further, the bottoms of each of the left U-shaped tube and the right U-shaped tube are connected with each other through a plastic connecting piece.

Further, third elastic sheets are mounted on the inner sides of the bottoms of each of the left U-shaped tube and the right U-shaped tube and are provided with third positioning columns; and third positioning holes, corresponding to the third positioning columns, are formed in the front sides and the back sides of the plastic connecting pieces.

Further, a tube reducing portion is arranged on the top of each foot tube connecting tube.

Further, each of the left connecting piece and the right connecting piece is provided with a sleeving portion; and the middle connecting tube is sleeved on the inner sides of the sleeving portions.

Further, fourth elastic sheets are mounted on the middle connecting tube and are provided with fourth positioning columns; and fourth positioning holes, corresponding to the fourth positioning columns, are formed in the sleeving portions.

Further, a grip is mounted on a top of each of the left U-shaped tube and the right U-shaped tube.

Further, a sleeve is arranged on a top of each foot tube.

Further, a foot pad is arranged at a bottom of each foot tube.

Compared with the prior art, for the present invention, the left connecting piece is hinged to the front side of the left U-shaped tube; the right connecting piece is hinged to the front side of the right U-shaped tube; the left connecting piece is connected with the right connecting piece through the middle connecting tube; first elastic sheets are mounted on the inner side of the front part of the left U-shaped tube and the inner side of the front part of the right U-shaped tube respectively, and each is provided with the first positioning column; the limiting grooves, corresponding to the first positioning columns, are formed in the outer side of the left connecting piece and the outer side of the right connecting piece respectively; each fixing sleeve is hinged to the corresponding handle through the handle pin; the spring abutting to each fixing sleeve is mounted at the upper part of each handle; the interlocking screw is mounted at the lower part of each handle; the locking holes, corresponding to each interlocking screws, are formed in the front part of the left U-shaped tube and the front part of the right U-shaped tube respectively; and the left U-shaped tube and the right U-shaped tube may both be folded toward the inner sides of the walking aid if the handles are lifted upward, so that the present invention is convenient to fold, ideal in use effect, small in packaging size, convenient to package and transport and low in production cost. The packaging size may further be reduced by disassembling the middle connecting tube. The foot tube is sleeved on the outer side of each foot tube connecting tube; the second elastic sheet is mounted on the inner side of each foot tube connecting tube and is provided with the second positioning column; and the plurality of second positioning holes, corresponding to each second positioning column, are formed in each foot tube, so that after the second positioning columns are pressed, the foot tubes may stretch, and then the present invention may be reduced in packaging size, is convenient to package and transport and is lowered in production cost.

### BRIEF DESCRIPTION OF THE DRAWINGS

In order to more clearly describe the technical solutions of the embodiments of the present invention or in the prior art, the accompanying drawings required to describe the embodiments or the prior art are briefly described below. Apparently, the accompanying drawings described below are only some embodiments of the present invention. Those of ordinary skill in the art may further obtain other accompanying drawings based on these accompanying drawings without inventive effort.

FIG. 1 is a schematic view of a structure of a walking aid convenient to fold and very small in size after being folded of the present invention;

FIG. 2 is an exploded view of a structure of a walking aid convenient to fold and very small in size after being folded of the present invention;

FIG. 3 is a schematic diagram of a structure of a left connecting piece of the present invention; and

FIG. 4 is a schematic diagram of a structure of a first elastic sheet of the present invention.

In the drawings: 1—left U-shaped tube; 2—right U-shaped tube; 3—left connecting piece; 4—right connecting piece; 5—middle connecting tube; 6—first elastic sheet; 7—first positioning column; 8—limiting groove; 9—rivet; 10—fixing sleeve; 11—handle pin; 12—handle; 13—spring; 14—interlocking screw; 15—locking hole; 16—foot tube connecting tube; 17—foot tube; 18—second elastic sheet; 19—second positioning hole; 20—plastic connecting piece; 21—third elastic sheet; 22—third positioning hole; 23—tube reducing portion; 24—sleeving portion; 25—fourth elastic sheet; 26—fourth positioning hole; 27—grip; 28—sleeve; 29—foot pad.

### DETAILED DESCRIPTION OF EMBODIMENTS

The technical solutions in the embodiments of the present invention are described clearly and completely in the following with reference to accompanying drawings in the embodiments of the present invention. Apparently, the described embodiments are only part rather than all of the embodiments of the present invention. Based on the embodiments of the present invention, all the other embodiments obtained by those of ordinary skill in the art without inventive effort are within the scope of the present invention.

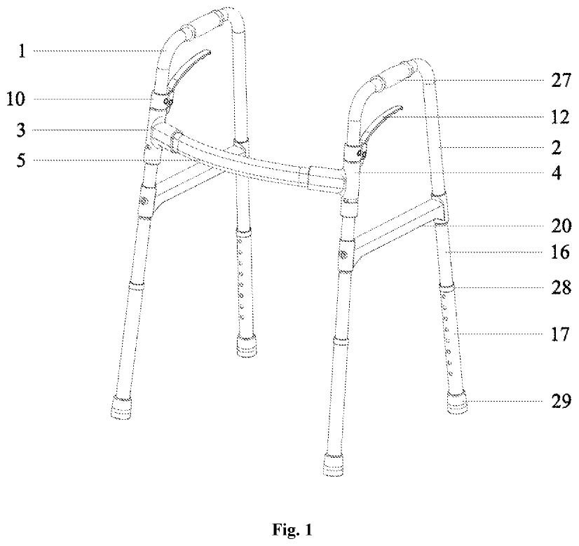

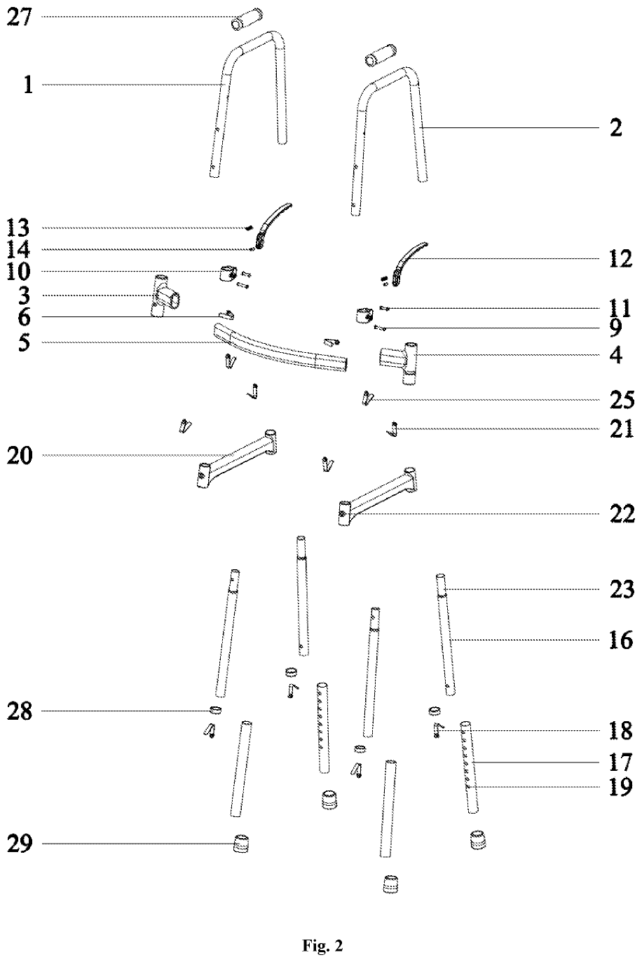

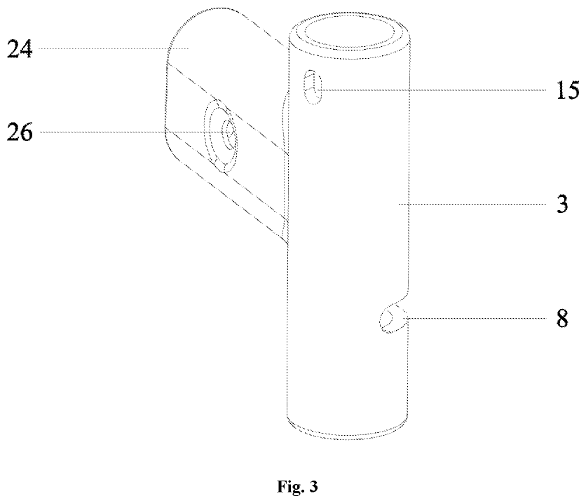

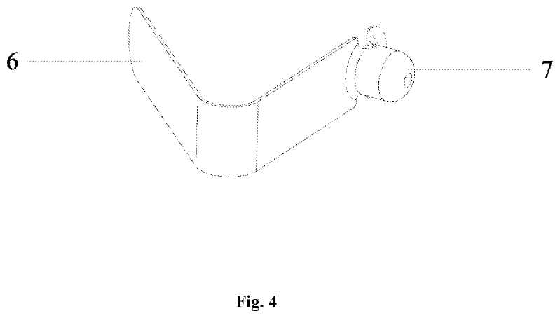

As shown in FIGS. 1-4, a walking aid convenient to fold and very small in size after being folded of the present invention comprises a left U-shaped tube 1 and a right U-shaped tube 2 which are inverted; a left connecting piece 3 is hinged to the front side of the left U-shaped tube 1; a right connecting piece 4 is hinged to a front side of the right U-shaped tube 2; the left connecting piece 3 is connected with a right connecting piece 4 through a middle connecting tube 5; first elastic sheets 6 are mounted on an inner side of a front part of the left U-shaped tube 1 and an inner side of a front part of the right U-shaped tube 2 respectively, and each is provided with a first positioning column 7; limiting grooves 8, corresponding to each first positioning columns 7, are formed in an outer side of the left connecting piece 3 and an outer side of the right connecting piece 4 respectively; fixing sleeves 10 are mounted on the front side of the left U-shaped tube 1 and the front side of the right U-shaped tube 2 through rivets 9 and are hinged to handles 12 through handle pins 11 respectively; a spring 13 abutting to each fixing sleeve 10 is mounted at an upper part of each handle 12; an interlocking screw 14 is mounted at a lower part of each handle 12; locking holes 15, corresponding to the interlocking screws 14, are formed in the front part of the left U-shaped tube 1 and the front part of the right U-shaped tube 2 respectively; foot tube connecting tubes 16 are sleeved on an inner side of the bottom of the left U-shaped tube 1 and an inner side of the bottom of the right U-shaped tube 2 respectively; a foot tube 17 is sleeved on an outer side of each foot tube connecting tube 16; a second elastic sheet 18 is mounted on an inner side of each foot tube connecting tube 16 and is provided with a second positioning column; and a plurality of second positioning holes 19, corresponding to each second positioning column, are formed in each foot tube 17. The left connecting piece 3 is hinged to the front side of the left U-shaped tube 1; the right connecting piece 4 is hinged to the front side of the right U-shaped tube 2; the left connecting piece 3 is connected with the right connecting piece 4 through the middle connecting tube 5; first elastic sheets 6 are mounted on an inner side of the front part of the left U-shaped tube 1 and an inner side of the front part of the right U-shaped tube 2, and each is provided with the first positioning column 7; the limiting grooves 8, corresponding to the first positioning columns 7, are formed in the outer side of the left connecting piece 3 and the outer side of the right connecting piece 4; each fixing sleeve 10 is hinged to the corresponding handle 12 through the handle pin 11; the spring 13 abutting to each fixing sleeve 10 is mounted at the upper part of each handle 12; the interlocking screw 14 is mounted at the lower part of each handle 12; the locking hole 15, corresponding to each interlocking screw 14, is formed in each of the front part of the left U-shaped tube 1 and the front part of the right U-shaped tube 2; and the left U-shaped tube 1 and the right U-shaped tube 2 may both be folded toward the inner sides of the walking aid if the handles 12 are lifted upward, so that the present invention is convenient to fold, ideal in use effect, small in packaging size, convenient to package and transport and low in production cost. The packaging size may further be reduced by disassembling the middle connecting tube 5. The foot tube 17 is sleeved on the outer side of each foot tube connecting tube 16; the second elastic sheet 18 is mounted on the inner side of each foot tube connecting tube 16 and is provided with the second positioning column; and the plurality of second positioning holes 19, corresponding to each second positioning column, are formed in each foot tube 17, so that after the second positioning columns are pressed, the foot tubes 17 may stretch, and then the present invention may be reduced in packaging size, is convenient to package and transport and is lowered in production cost.

The bottoms of each of the left U-shaped tube 1 and the right U-shaped tube 2 are connected with each other through a plastic connecting piece 20, and thus the stability of the structures of the left U-shaped tube 1 and the right U-shaped tube 2 is improved.

Third elastic sheets 21 are mounted on the inner sides of the bottoms of the left U-shaped tube 1 and the right U-shaped tube 2 and are provided with third positioning columns respectively; and third positioning holes 22, corresponding to the third positioning columns, are formed in front sides and back sides of the plastic connecting pieces 20 respectively, so that mounting and connection of the plastic connecting piece 20 are rapid and convenient.

A tube reducing portion 23 is arranged on the top of each foot tube connecting tube 16, so that stable and rapid connection among the foot tube connecting tubes 16, the left U-shaped tube 1 and the right U-shaped tube 2 is facilitated.

Each of the left connecting piece 3 and the right connecting piece 4 is provided with a sleeving portion 24; and the middle connecting tube 5 is sleeved on the inner sides of the sleeving portions 24, so that rapid alignment and mounting of the middle connecting tube 5 is facilitated.

Fourth elastic sheets 25 are mounted on the middle connecting tube 5 and are provided with fourth positioning columns respectively; and fourth positioning holes 26, corresponding to the fourth positioning columns, are formed in the sleeving portions 24 respectively, so that rapid mounting and disassembly of the middle connecting tube 5 is facilitated.

A grip 27 is mounted on the top of each of the left U-shaped tube 1 and the right U-shaped tube 2, so that the walking aid is convenient to use by hand holding.

A sleeve 28 is arranged on the top of each foot tube 17, so that each foot tube 17 has a more stable structure and is more stable in stretching.

A foot pad 29 is arranged at the bottom of each foot tube 17, so as to exert the antiskid effect, and thus the use is safer.

The foregoing is only preferred exemplary embodiments of the present invention and is not intended to be limiting of the present invention, and any modifications, equivalent substitutions, improvements and the like within the spirit and principles of the present invention are intended to be embraced by the protection range of the present invention.

What is claimed is:

1. A walking aid convenient to fold and very small in size after being folded, comprising a left U-shaped tube and a right U-shaped tube which are inverted, wherein a left connecting piece is hinged to a front side of the left U-shaped tube; a right connecting piece is hinged to a front side of the right U-shaped tube; the left connecting piece is connected with the right connecting piece through a middle connecting tube; first elastic sheets are mounted on an inner side of a front part of the left U-shaped tube and an inner side of a front part of the right U-shaped tube respectively, and each is provided with a first positioning column; limiting grooves, corresponding to the first positioning columns, are formed in an outer side of the left connecting piece and an outer side of the right connecting piece; fixing sleeves are mounted on the front side of the left U-shaped tube and the front side of the right U-shaped tube through rivets and are hinged to handles through handle pins respectively; a spring abutting to each fixing sleeve is mounted at an upper part of each handle; an interlocking screw is mounted at a lower part of each handle; locking holes, corresponding to the interlocking screws, are formed in the front part of the left U-shaped tube and the front part of the right U-shaped tube respectively; foot tube connecting tubes are sleeved on an inner side of a bottom of the left U-shaped tube and an inner side of a bottom of the right U-shaped tube respectively; a foot tube is sleeved on an outer side of each foot tube connecting tube; a second elastic sheet is mounted on an inner side of each foot tube connecting tube and is provided with a second positioning column; and a plurality of second positioning holes, corresponding to each second positioning column, are formed in each foot tube.

2. The walking aid convenient to fold and very small in size after being folded according to claim 1, wherein the bottoms of each of the left U-shaped tube and the right U-shaped tube are connected with each other through a plastic connecting piece.

3. The walking aid convenient to fold and very small in size after being folded according to claim 2, wherein third elastic sheets are mounted on inner sides of the bottoms of the left U-shaped tube and the right U-shaped tube and are provided with third positioning columns respectively; and third positioning holes, corresponding to the third positioning columns, are formed in front sides and back sides of the plastic connecting pieces.

4. The walking aid convenient to fold and very small in size after being folded according to claim 1, wherein a tube reducing portion is arranged on a top of each foot tube connecting tube.

5. The walking aid convenient to fold and very small in size after being folded according to claim 1, wherein each of the left connecting piece and the right connecting piece is provided with a sleeving portion; and the middle connecting tube is sleeved on inner sides of the sleeving portions.

6. The walking aid convenient to fold and very small in size after being folded according to claim 5, wherein fourth elastic sheets are mounted on the middle connecting tube and are provided with fourth positioning columns respectively; and fourth positioning holes, corresponding to the fourth positioning columns, are formed in the sleeving portions respectively.

7. The walking aid convenient to fold and very small in size after being folded according to claim 1, wherein a grip is mounted on a top of each of the left U-shaped tube and the right U-shaped tube.

8. The walking aid convenient to fold and very small in size after being folded according to claim 1, wherein a sleeve is arranged on a top of each foot tube.

9. The walking aid convenient to fold and very small in size after being folded according to claim 1, wherein a foot pad is arranged at a bottom of each foot tube.
